(19) United States
(12) Patent Application Publication
(10) Pub. No.: US 2024/0426223 A1
(43) Pub. Date: Dec. 26, 2024

(54) BLADE FOR A CONTINUOUS FLOW MACHINE AND METHOD FOR PRODUCING A BLADE, WHEREIN THE BLADE HAS A BLADE TIP WITH NOTCHES IN AN ABRADABLE COATING SURFACE

(71) Applicant: Siemens Energy Global GmbH & Co. KG, Munich, Bayern (DE)

(72) Inventors: Jochen Barnikel, Mulheim an der Ruhr (DE); Bertold Lübbe, Mülheim an der Ruhr (DE); Norbert Sürken, Mülheim a.d. Ruhr (DE); Hannes Teuber, Bocholt (DE)

(73) Assignee: Siemens Energy Global GmbH & Co. KG, Munich, Bayern (DE)

(21) Appl. No.: 18/700,812

(22) PCT Filed: Sep. 9, 2022
(86) PCT No.: PCT/EP2022/075072

§ 371 Date: Apr. 12, 2024

(30) Foreign Application Priority Data
Oct. 20, 2021 (EP) 21203824.4

(51) Int. Cl. F01D 11/12; F01D 5/20

(52) U.S. Cl. CPC F01D 11/122; F01D 5/20; F05D 2300/224; F05D 2300/2282

(57) ABSTRACT

A blade for a continuous flow machine, wherein the blade is formed along a radial direction and has a blade tip and a blade cross-sectional profile with a pressure side and a suction side. The blade has a blade tip surface which is opposite a housing inner wall during operation. The blade tip surface has an abradable coating, wherein the abradable coating is formed in such a way that a wearing away of the abradable coating takes place during operation, when coming into contact with the housing inner wall, wherein the abradable coating is formed with an abradable coating surface, wherein notches are arranged in the abradable coating surface.

### CROSS REFERENCE TO RELATED APPLICATIONS

This application is the US National Stage of International Application No. PCT/EP2022/075072 filed 9 Sep. 2022, and claims the benefit thereof, which is incorporated by reference herein in its entirety. The International Application claims the benefit of European Application No. EP21203824 filed 20 Oct. 2021.

### FIELD OF INVENTION

The invention relates to a blade for a continuous flow machine, wherein the blade is formed along a radial direction and has a blade tip and a blade cross-sectional profile with a pressure side and a suction side, wherein the blade has a blade tip surface which is opposite a housing inner wall during operation, wherein the blade tip surface has an abradable coating.

The invention also relates to a method for producing an abradable coating.

### BACKGROUND OF INVENTION

In continuous flow machines for treating and processing flowing, liquid and/or gaseous media, gaps between moving and stationary components frequently have to be sealed off with respect to the flowing medium. Examples of a continuous flow machine are steam turbines, gas turbines, compressors and so on.

In steam turbines, a gap between a rotor and a housing surrounding the latter is sealed off in order to block a path for the steam past blade rings. The quality of these seals has a considerable influence on the efficiency of these continuous flow machines.

In a continuous flow machine, use is made of the principle of changing angular momentum to convert internal energy of a working fluid into mechanical energy of a rotating component. In order that the working fluid cannot leave the process, the components carrying flow are generally closed, so that the result is an internal flow.

In order to permit trouble-free rotation of a continuous flow machine component in a geometry carrying flow, radial gaps between stationary and rotating components are absolutely necessary.

The radial gaps have to be as small as possible here in order to reduce losses and, from the point of view of integrity, must be designed to be as large as necessary.

In general, the radial gap between a rotor blade tip of a blade in a continuous flow machine and the opposite housing is designed in such a way that bridging of the radial gap is avoided in every operating case that is to be assumed expediently.

In a low-pressure steam turbine, as an embodiment of a continuous flow machine, there is also the problem of droplet impingement erosion. The expansions in these continuous flow machines frequently end here in a two-phase region of the water vapor, which leads to high erosion loadings of the rotating and the adjacent stationary components.

In continuous flow machines, such as in steam turbines, self-supporting low-pressure blades are primarily used in the low-pressure area. In design terms, such continuous flow machines have a comparatively large radial gap between the blade tip and the housing. In order that the losses nevertheless do not become too large, it is known to arrange abrasive coatings on the housing opposite the blade tip. In the event of contact between the blade tip and the housing, only the abrasive coating is slightly worn away, as a result of which a comparatively small radial gap is produced.

In principle, the radial gaps are primarily minimized by passive design measures while considering the principles of mechanics (radial lengthening of the blade under the influence of centrifugal force and temperature). In addition to minimizing housing ovalizations and shaft vibrations, for example, cylindrically lengthened blades are used, which minimize influences of axial differential expansion.

On the active side, (hydro-) mechanical devices for influencing the axial position of the rotor are used in rotors for conically lengthened blades.

In housings, both active and also semi-passive and passive solutions to influencing the radial play are found.

The active solutions include the “retractable sealing segments”, which close only when the flow has been built up and reduce the radial play at nominal rotational speed. In the event of bridging, spring constructions in the circumferential direction permit widening of the housing geometry.

The semi-passive “sprung seal segments”, in which spring constructions in the radial direction permit widening of the housing geometry, function in a similar way.

The passive solutions include abrasion-tolerant insert/attachment components and component parts and also abrasive coatings.

Abrasion-tolerant abrasive coatings are often found on the opposite housing side.

However, in droplet-loaded flows, these functional coatings fail since, because of their function, they cannot withstand high mechanical forces, for example caused by droplet impingement erosion.

What are known as honeycomb seal segments, which have anisotropic abrasion properties and can be embedded in the housing wall, promise a remedy. The problem here in practical use is that the resultant hollow structures can be filled with solid material particles which are present in the working medium, and then lose their positive anisotropic properties.

From time to time in self-supporting impeller blades, seal-tip-like designs, which likewise have the object of gap loss reduction, are also found on the opposite housing side.

Turbine blades with abrasion coatings are disclosed in documents DE 698 26 096 T2,US 2019/309759 A1, US 9 845 685 B2, US 5 434 210 A and US 2020/277871 A1.

### SUMMARY OF INVENTION

It is an object of the invention to specify a blade for a continuous flow machine which can be used in a continuous flow machine and leads to low gap losses during operation.

This object is achieved by a blade for a continuous flow machine, wherein the blade is formed along a radial direction and has a blade tip and a blade cross-sectional profile with a pressure side and a suction side, wherein the blade has a blade tip surface which is opposite a housing inner wall during operation, wherein the blade tip surface has an abradable coating, wherein the abradable coating is formed in such a way that the abradable coating is worn away during operation when coming into contact with the housing inner wall, wherein the abradable coating (8) has an abradable coating surface (11) and notches (12) are arranged on the abradable coating surface (11).

The invention thus follows the path of applying an abradable coating to the blade tip. The abradable coating is formed here in such a way that, in the event of contact of the abradable coating with the housing, it is such that the abradable coating is abrasive or abradable, i.e. that the radial gap is optimized as a result of material removal of the abradable coating.

The individual pieces of material which are produced by the abrasive action and remain in the continuous flow machine during operation are configured such that these do not cause any damage in the continuous flow machine. To this end, the individual pieces of material are comparatively small, which is achieved by the configuration according to the invention of the abradable coating.

The solution according to the invention is a novel way since, hitherto, the housing inner wall was formed with an abrasive coating if needed, since here residual ovalities of the housing contour can be compensated for with low costs.

As compared with a coating of the stationary part, the coating of the blade has advantages in the following situation: when variations occur in the radial length of the blades and/or ovality of the housing, only the coating of the longest blade is removed abrasively in the event of abrasion. The gaps of the remaining blades remain unchanged.

According to the invention, the abradable coating has an abradable coating surface, wherein notches are arranged on the abradable coating surface.

It is achieved with this measure that, during the material removal via the contact with the housing inner wall, the individual pieces of material that are removed do not become too large. The notches act basically like an intended fracture point and lead to a piece of material being removed as far as a notch which, as a result, can be designated in other words as a boundary as far as which flaking off of the abradable coating is possible.

In other words, the abradable coating is segmented normally to the median line of the blade tip profile. As a result, any instances of flaking, partial losses or removals are limited. The segmentation can be produced here both by material removal and can already be produced during the coating process itself.

Advantageous developments are specified in the sub-claims.

Thus, in a first advantageous development, the abradable coating is provided with a lubricant.

Here, the lubricant has abrasive properties. This means that in the event of contact of the abradable coating with a housing inner wall, material removal of the abradable coating occurs, wherein the material property of the abradable coating is such that the individual pieces of material are sufficiently small that the risk of damage by a removed piece of material flying about is minimized.

In a further advantageous development, the lubricant comprises graphite and/or hexagonal boron nitride.

In particular, graphite and/or hexagonal boron nitride have material properties which are ideal for the use as an abrasive coating or as a constituent part of abrasive coatings in a continuous flow machine. The crystal structure and bonding forces in graphite and/or hexagonal boron nitride are such that it is possible for material removal of the abradable coating to occur in which the individual pieces of material removed are sufficiently small.

In a further advantageous development, the blade cross-sectional profile can be described with a median line, wherein the abradable coating is arranged along the median line.

In a further advantageous development, the blade has a leading edge and a trailing edge, wherein the abradable coating is arranged from the leading edge as far as the trailing edge.

In an advantageous development, the median line has a length D, and the abradable coating is arranged only in a region upstream of the trailing edge, wherein: d=(0.4 to 0.9)×D, where d is the length of the abradable coating along the median line as far as the trailing edge.

With this advantageous development, it is thus proposed not to provide the whole of the airfoil surface with the abradable coating but, in principle, merely only the region upstream of the trailing edge.

Advantageously, the notches are formed substantially perpendicular to the median line.

Likewise, the notches are advantageously formed at equidistant intervals from one another.

In an advantageous development, the abradable coating is formed continuously from the pressure side as far as the suction side.

In an advantageous development, the abradable coating is formed in such a way that abrasion with a housing inner wall occurring during operation leads to the abradable coating being removed, wherein, as a result, a contact surface produced by abrasion is produced, wherein the contact surface becomes wider in the radial direction toward the blade root as a result of further abrasion.

With this measure, an initial process is made possible in which the abradable coating is, so to speak, rubbed in. This means that a contact surface between the abradable coating and the housing inner wall becomes larger and larger during further contacts between the abradable coating and the housing inner wall.

For this purpose, the abradable coating is advantageously formed on the blade tip surface in such a way that the abradable coating, viewed in cross section, represents a tip at an obtuse angle.

In other words: the abradable coating is aimed at the housing inner wall like a blunt tip. In the event of abrasion of the abradable coating on the housing inner wall, the tip is removed first. During increasing contact, the contact surface becomes wider and wider here.

In a particularly advantageous development, the abradable coating has a slot, which is arranged in such a way that removal of the abradable coating leads to a measurable length L of the slot, and a height of the coating can be determined via the length L.

This slot thus provides an indicator with which it is easy to find out the extent to which the abradable coating has been removed or how thick the abradable coating is.

The slot can be introduced both over the entire width of the abradable coating and also over part of the width of the abradable coating.

In an advantageous development, a plurality of slots per blade are arranged in the abradable coating.

The slot is machined in from the edge of the blade surface of the suction side or pressure side as far as the tip here. If the tip is worn away during operation, in the plan view of the abradable coating, a slot length can be measured in the plane with which, via geometric properties and trigonometric considerations, the thickness of the abradable coating can be calculated.

The slots can perform the function of the notches and likewise serve as an intended fracture point. Thus, the fragment sizes can be limited by the slots.

The object directed toward the method is achieved by a method for producing an abradable coating on a blade surface, wherein the abradable coating is applied to the blade tip by means of a thermal spray coating process, such as APS or HVOF, wherein the abradable coating is provided with a lubricant, such as graphite and/or hexagonal boron nitride, wherein the abradable coating (8) is formed with an abradable coating surface (11), wherein notches (12) are arranged on the abradable coating surface (11).

Advantageously, a polymer is added to the abradable coating to produce a porous structure of the abradable coating.

In a particularly advantageous development, before the application of the abradable coating to the blade, a first thermal treatment is carried out, in which the blade is hardened, wherein the abradable coating is applied after the first thermal treatment, wherein, following the application of the abradable coating, a second thermal treatment is carried out at a temperature at which the blade is low-stress-annealed, wherein the temperature is chosen such that the polymer melts in the abradable coating sprayed on and, as a result, gives rise to a porous structure of the abradable coating.

It is achieved with this advantageous method that the polymer melts during the second thermal treatment and is removed from the abradable coating, as a result of which, in a simple and cost-effective variant, the abradable coating is imparted a porous structure.

In an advantageous development, notches which are arranged along the median line are applied to the abradable coating, wherein the notches are produced during the coating process or after the coating process by a material-removing method, such as milling.

The invention is explained in more detail below with reference to specific exemplary embodiments with reference to drawings.

The above-described properties, features and advantages of this invention and the manner in which these are achieved become clearer and considerably more comprehensible in conjunction with the following description of the exemplary embodiments, which are explained in more detail in connection with the drawings.

The same components or components with the same function are identified here with the same designations.

Exemplary embodiments of the invention are described below with reference to the drawings. These are intended not to illustrate the exemplary embodiments to scale, instead the drawing, where helpful for explanation, is made in a schematic and/or slightly distorted form. With regard to extensions of the teachings that can be detected directly in the drawing, reference is made to the relevant prior art.

### BRIEF DESCRIPTION OF THE DRAWINGS

In the drawings:

FIG. 1 shows a perspective illustration of a turbine blade according to the invention,

FIG. 2 shows an enlarged illustration of a detail of the turbine blade according to the invention,

FIG. 3 shows a plan view of a blade surface of the blade according to the invention,

FIG. 4 shows a plan view of a blade surface of the blade according to the invention,

FIG. 5 shows a schematic illustration of the blade tip of the blade according to the invention,

FIG. 6 shows a schematic illustration of a detail of the blade according to the invention.

### DETAILED DESCRIPTION OF INVENTION

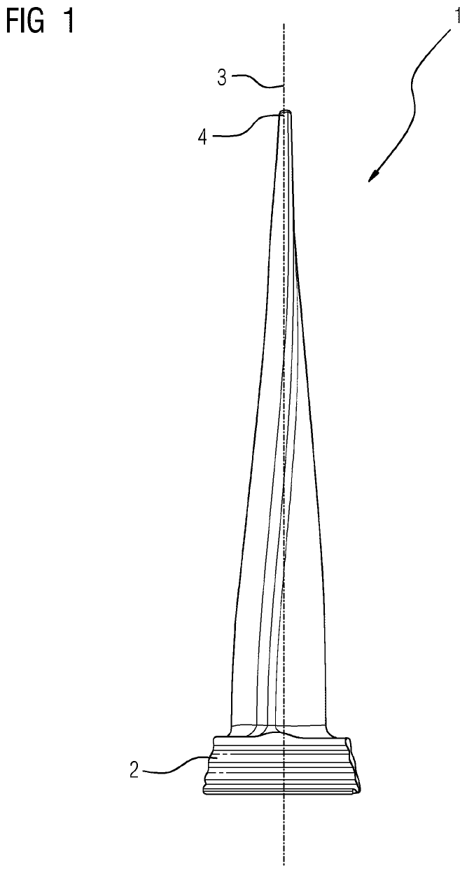

In FIG. 1, a blade 1 can be seen in a perspective illustration. The blade 1 has a blade root 2, which is suitable to be fixed in a rotor, not illustrated. The blade root 2 here has what is known as a Christmas-tree root form. Still further embodiments are known for the blade root 2, such as snap-in and straddle-root, Laval-root, hook-root or T-root designs. Such blades 1 can be used in continuous flow machines, such as steam turbines, gas turbines or compressors. The blade 1 is formed along a radial direction 3 and has a blade tip 4 and a blade profile with a pressure side 5 and a suction side 6.

The blade 1 has differently formed blade cross-sectional profiles along the radial direction 3.

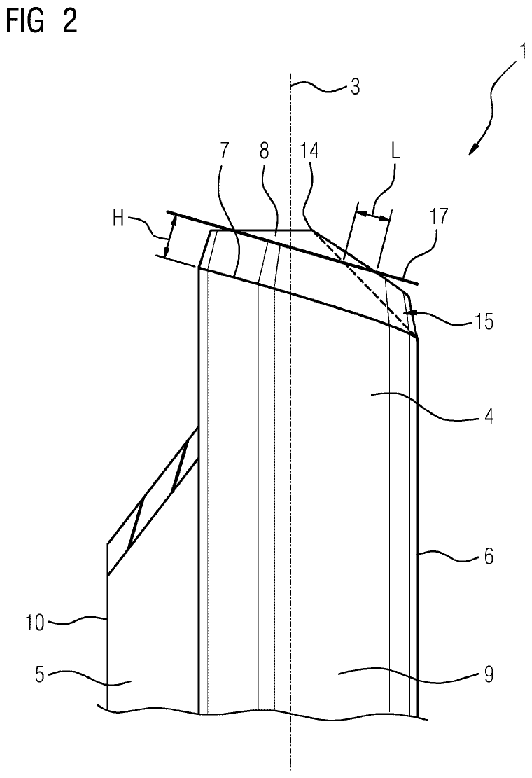

FIG. 2 shows an enlarged illustration of the blade tip 4 of the blade 1. The blade tip 4 has here a blade tip surface 7 which is opposite a housing inner wall (not illustrated) during operation.

The blade tip surface 7 is inclined at an angle with respect to the radial direction 3, wherein the blade tip surfaces 7 are consequently formed substantially parallel to the housing inner wall.

Arranged on the blade tip surface 7 is an abradable coating 8. The abradable coating 8 is applied here to the blade tip surface 7 essentially for the further improvement of the gap losses. The abradable coating 8 is formed here as an abrasive wear coating in which, during contact with the inner housing, the risk of damage is minimized. The abradable coating 8 is thus formed in such a way that the abradable coating 8 is worn away when coming into contact with the housing inner wall during operation.

In order to allow the abradable coating 8 to be worn away, the abradable coating 8 is made of a lubricant. Here, the lubricant comprises graphite and/or hexagonal boron nitride.

In order to improve the abrasive property of the abradable coating 8 and to permit the abradable coating 8 to be worn away, the abradable coating 8 is porous. This means that comparatively many small voids are formed in the abradable coating 8.

The voids, as a result of which porosity of the abradable coating 8 arises, are produced as described below.

In a first step, a method for producing the abradable coating 8 on a blade surface 7 is carried out. The abradable coating 8 is applied here to the blade tip surface 7 by means of a thermal spray coating process, such as APS or HVOF, wherein the abradable coating 8 is provided with a lubricant, such as graphite and/or hexagonal boron nitride.

In addition, a polymer is added to the abradable coating 8 to produce the porous structure of the abradable coating 8.

In a next step, before the application of the abradable coating 8, a first thermal treatment is carried out in which the blade 1 is hardened.

After the first thermal treatment, the abradable coating 8 is applied, wherein, following the application of the abradable coating 8, a second thermal treatment is carried out at a temperature at which the blade 1 is low-stress-annealed. The temperature is chosen here in such a way that the polymer in the abradable coating 8 sprayed on melts. As a result, small voids arise in the abradable coating 8, which ultimately lead to a porous structure of the abradable coating 8.

The blade 1 can be produced from steel, titanium or else composite materials.

FIG. 4 shows a view of the blade tip 4 in the direction of the leading edge 9.

The blade cross-sectional profile of the blade 1 can be described with a median line, which is familiar practice in continuous flow machine construction. The abradable coating 8 is arranged here along the median line. In a first embodiment, the abradable coating 8 accordingly covers the entire blade tip surface 7.

The blade 1 further has a leading edge 9 and a trailing edge 10, wherein the abradable coating 8 is arranged from the leading edge 9 as far as the trailing edge 10 in the first embodiment.

In a further alternative embodiment, the length of the median line is D, wherein the abradable coating 8 is arranged only in a region upstream of the trailing edge 10, wherein: d=(0.4 to 0.9)×D, where d is the length of the abradable coating 8 along the median line as far as the trailing edge 10.

Thus, in this alternative embodiment, the whole blade 1 does not have to be formed with the abradable coating 8, instead only a region upstream of the trailing edge 10.

The abradable coating 8 has an abradable coating surface 11, wherein notches 12 are arranged on the abradable coating surface 11.

The notches 12 are applied here to the abradable coating surface 11 in such a way that, during operation, flaking off of the abradable coating 8 leads only to a segment 13 arranged between two notches 12 flaking off. The notches 12 can accordingly be considered as intended fracture points, at the locations of which a fracture of the abradable coating 8 is intended, for the case in which operating conditions occur which lead to the abradable coating 8 being subjected to material-removing conditions.

The notches 12 are formed here substantially perpendicularly to the median line, which reduces the outlay on fabrication. Furthermore, the notches 12 are arranged at equidistant intervals along the median line.

The notches 12 are produced during the coating process or after the coating process using a material-removing method, such as milling.

During the production of the abradable coating 8 on the blade tip surface 7, the abradable coating 8 is formed continuously from the pressure side 5 as far as the suction side 6.

The abradable coating 8 is formed in such a way that abrasion occurring during operation with a housing inner wall leads to the abradable coating 8 wearing out, wherein a contact surface (not illustrated) arising as a result of removal is produced as a result, wherein the contact surface becomes wider in the radial direction 3 toward the blade root 2 as a result of further abrasion.

For this purpose, the abradable coating 8 is formed on the blade tip surface 7 in such a way that the abradable coating 8, viewed in cross section, represents a tip 14 at an obtuse angle.

In order to be able to determine the condition of the abradable coating 8, the abradable coating 8 is formed with an abrasion indicator 15. To this end, the abradable coating 8 has a slot 16, which is arranged in such a way that wear of the abradable coating 8 leads to a measurable length L of the slot, and a height of the abradable coating 8 can be determined via the length L.

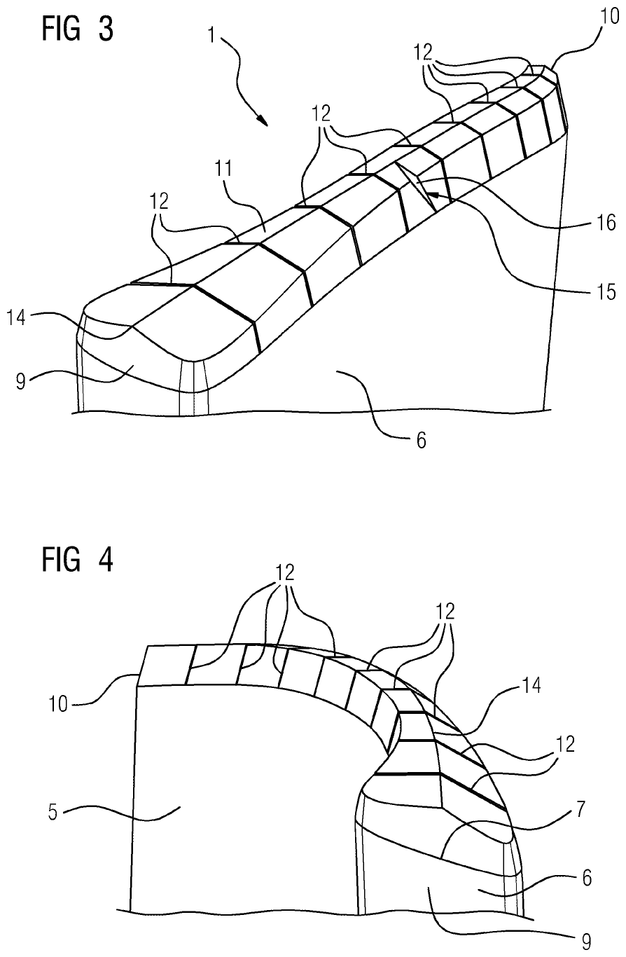

For this purpose, the slot 16 is introduced from the edge on the pressure side 5 as far as the tip 14, which is illustrated in FIG. 3. A lateral illustration of the abrasion indicator 15 can be seen in FIG. 2.

During operation, the abradable coating 8 can be worn off, so that the contact surface, which is illustrated by a line 17 in FIG. 2, becomes wider and wider. This line 17 is arranged substantially parallel to the blade tip surface 7.

In this state, a measurable slot 16 of the length L is visible. By determining L, a height H of the abradable coating 8 can thus be determined by simple trigonometric geometry considerations. Therefore, so to speak with a glance at the length L of the slot 16, it is possible to infer the condition of the abradable coating 8.

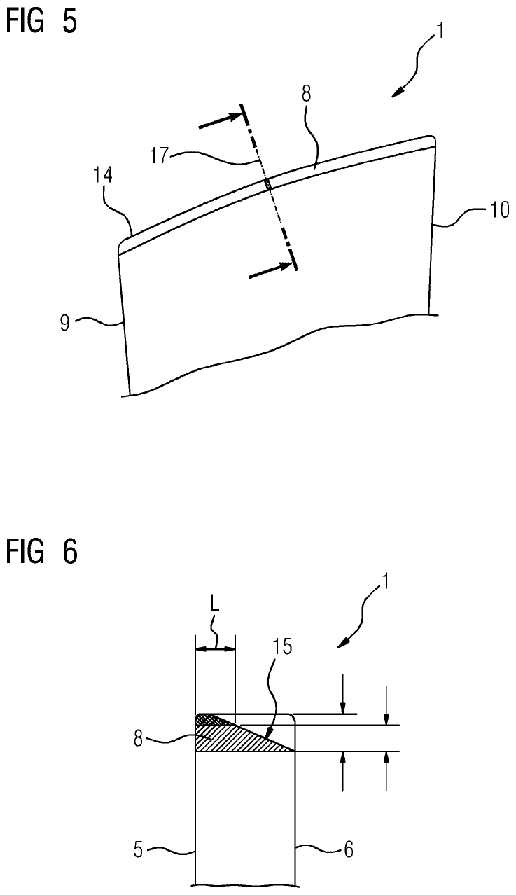

In FIGS. 5 and 6, the abrasion indicator 15 is illustrated schematically in more detail, wherein FIG. 6 shows a sectional illustration of FIG. 5 along the line 17.

Preferably, the curved blade tips 4 are used in low-pressure final-stage blades in low- pressure steam turbines. The peripheral speed of the blade tip 4 here can be at values of greater than Mach 1. As a result, use in the aerodynamic region of subsonic, trans-sonic and supersonic flows is possible.

The above features of a blade 1 can be varied within a row of blades in a continuous flow machine.

The blade 1 is used in a wet steam flow.

In addition, the above features can be varied from blade row to blade row and from turbine flow to turbine flow, depending on the machine construction and the operational requirements.

The invention can be combined with a non-contact blade vibration measurement system, since the distance of the blade tip 4 from the transducer can be minimized by the abradable coating 8.
The following listing of claims will replace all prior versions, and listings, of claims in the application:

1. A blade for a continuous flow machine, wherein the blade is formed along a radial direction, comprising:
a blade tip and a blade cross-sectional profile with a pressure side and a suction side,
wherein the blade comprises a blade tip surface which is opposite a housing inner wall during operation,
wherein the blade tip surface comprises an abradable coating,
wherein the abradable coating is formed in such a way that the abradable coating is worn away during operation when coming into contact with the housing inner wall,
wherein the abradable coating comprises an abradable coating surface, wherein notches are arranged on the abradable coating surface.

2. The blade as claimed in claim 1, wherein the abradable coating is provided with a lubricant.

3. The blade as claimed in claim 2, wherein the lubricant comprises graphite and/or hexagonal boron nitride.

4. The blade as claimed in claim 1,
wherein the blade cross-sectional profile can be described with a median line, wherein the abradable coating is arranged along the median line.

5. The blade as claimed in claim 1,
wherein the blade has a leading edge and a trailing edge, wherein the abradable coating is arranged from the leading edge as far as the trailing edge.

6. The blade as claimed in claim 4,
wherein a length of the median line is D and the abradable coating is arranged only in a region upstream of a trailing edge, wherein: d=(0.4 to 0.9)×D, where d is the length of the abradable coating along the median line as far as the trailing edge.

7. The blade as claimed in claim 4, wherein the notches are formed substantially perpendicularly to the median line.

8. The blade as claimed in claim 1, wherein distances of the notches from one another are equidistant.

9. The blade as claimed in claim 1,
wherein the abradable coating is formed continuously from the pressure side as far as the suction side.

10. The blade as claimed in claim 1,
wherein the abradable coating is formed in such a way that abrasion occurring during operation by a housing inner wall leads to the abradable coating being worn away, wherein, as a result, a contact surface produced by abrasion is produced, wherein the contact surface becomes wider in the radial direction toward a blade root as a result of further abrasion.

11. The blade as claimed in claim 1,
wherein the abradable coating is formed on the blade tip surface in such a way that the abradable coating, viewed in cross section, represents a tip at an obtuse angle.

12. The blade as claimed in claim 1,
wherein the abradable coating has a slot, which is arranged in such a way that wear of the abradable coating leads to a measurable length L of the slot, and a height of the abradable coating can be determined via the length L.

13. A method for producing an abradable coating on a blade tip surface, comprising:
applying the abradable coating to the blade tip surface by a thermal spray coating process, such as APS or HVOF, wherein the abradable coating is provided with a lubricant, such as graphite and/or hexagonal boron nitride,
forming the abradable coating with an abradable coating surface, wherein notches are arranged on the abradable coating surface.

14. The method as claimed in claim 13, further comprising:
adding a polymer to the abradable coating to produce a porous structure of the abradable coating.

15. The method as claimed in claim 13,
wherein, before application of the abradable coating of a first thermal treatment, the blade is carried out, in which the blade is hardened, wherein, after the first thermal treatment, the abradable coating is applied, wherein, following the application of the abradable coating, a second thermal treatment is carried out at a temperature at which the blade is low-stress-annealed, wherein the temperature is chosen in such a way that the polymer in the abradable coating sprayed on melts and as a result gives rise to a porous structure of the abradable coating.

16. The method as claimed in claim 13,
wherein a blade cross-sectional profile can be described with a median line.
wherein notches which are arranged along the median line are applied to the abradable coating, wherein the notches are produced during the coating process or after the coating process by a material-removing method, such as milling.
